(19) United States
(12) Patent Application Publication
(10) Pub. No.: US 2007/0294258 A1
(43) Pub. Date: Dec. 20, 2007

(54) System and method for incident reporting

(75) Inventors: Mark Caldwell, Katy, TX (US); Steve Brack, The Woodlands, TX (US); Rosemary Beauvais, Houston, TX (US); Bohdan Horyn, Hicksville, NY (US); Robert Francis Roche, Angleton, TX (US); Thomas G. Kelly, Katy, TX (US); J. Steven Senneff, Houston, TX (US); Ronald E. Mahaffey, East Williston, NY (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/471,399

(22) Filed: Jun. 20, 2006

(51) Int. Cl. G06F 17/30

(52) U.S. Cl. 707/10

(57) ABSTRACT

A system and method for incident reporting uses an application server on a network to facilitate the creation of incident reports and distribution of the reports for review, and controls access to the incident reports to protect the integrity and confidentiality of the reports. Each incident report is given a routing profile, which is tailored such that only proper authorized persons can review and/or edit the report. The progress of incident report review and incident investigation is tracked, and the tracking data are stored for monitoring and auditing purposes. Access to selected reports may be given to users on a temporary basis. The incident reports are archived to enable auditing and generation of reports.

### FIELD OF THE INVENTION

The invention generally relates to incident management, and more particularly to a networked system and method for the creation and review of incident reports, incident investigations, and other related documents.

### BACKGROUND OF THE INVENTION

In every business setting, events that are not part of the standard business practice may take place and cause interruption to the business operation. Such events, commonly referred to as “incidents,” can potentially reduce the quality of the services or products of the business, and sometimes may impose civil or even criminal liabilities on the business. The particular types of incidents of significance to the business depend on the nature of the business. For many businesses, incidents to be reported often include events such as injuries, theft, vehicle accidents, various code/rule violations, and security violations, human resources incidents, compliance incidents, etc.

To handle incidents that have occurred and to prevent future incidents, many companies have implemented systems for incident management. The first step of incident management is to create incident reports for the incidents. Once created, the incident reports are forwarded to responsible persons for review. The incident report review is often performed by managers and directors at different levels. The review of an incident report may trigger investigation of the incident if necessary, and result in the resolution of the incident.

In conventional incident management systems, a major issue is the distribution of incident reports and tracking of the progress of the reviews to ensure timely resolution of the incidents. Depending on the types of incidents and other factors such as geographical locations, corporate organization, etc., different incident reports may have to be reviewed by different groups of reviewers on different management levels. The existence of multiple review routing paths can be rather confusing, making it difficult to ensure that the report is routed to the right reviewers in the right order. Any attempt to modify the routing paths for special cases can further complicate the distribution of the reports. Moreover, with many incident reports created in the course of business and the requirement of review by multiple levels of reviewers for each report, it can be very difficult to keep track the progress of the review process. An incident report may be misplaced or lost during transit to the next reviewer, or be stalled at a reviewer who is the bottleneck in the review chain, and the exact status of the report may be hard to find out. It is often difficult to track which reviewers have reviewed the report, whether the report has been modified by any reviewer, and which actions have been taken in connection with the incident.

Another significant concern regarding the conventional incident management systems is the lack of effective control over the access to the incident reports. Incident reports often contain sensitive or confidential information that should be viewed only by authorized reviewers. The necessary access control, however, can be difficult to implement or enforce due to the lack of effective measures to prevent unauthorized access to the documents or other factors such as distribution errors.

### SUMMARY OF THE INVENTION

In view of the foregoing, it is an object of the invention to provide a system and method for incident reporting that makes incident reporting simple and reliable, and provides improved data protection, enhanced management of distribution of incident reports, and secure yet flexible control over the access to the incident reports and related information.

It is a related object of the invention to provide a system and method for incident reporting that enables tracking of the up-to-date review status of incident reports and facilitates auditing of the report reviews.

These objects and other related projects are achieved by the present invention, which provides a computer-assisted network-based system and method for incident reporting. The system in accordance with the invention uses electronic report forms to facilitate and standardize the creation of incident reports. The system further controls the distribution of incident reports by requiring a routing profile for each incident report. The routing profile may be selected from a list of pre-defined routing profiles, or be tailored for a particular incident being reported. Role-based security is implemented to control access to the incident reports and related documents by different users. Data encryption is used to protect the incident reporting data as stored in a database and in transit over the network. The forwarding of an incident report along a chain of reviewers is controlled and logged by an application server, and changes to the incident reports and investigations are monitored and recorded. As a result, the progress of the review process can be easily monitored, and the logged data enables auditing of the report reviews and generation of reports on the reported incidents.

The advantages of the invention can be understood from the description of embodiments of the invention set forth below with reference to the drawings, in which:

### BRIEF DESCRIPTION OF THE DRAWING(S)

FIG. 1 is a schematic diagram showing an embodiment of a networked system for incident reporting in accordance with the invention;

FIG. 2 is a block diagram showing an example of a hierarchical structure for incident reporting and review;

FIG. 3 shows a user interface screen showing a user home page presented by the incident reporting system to a user;

FIG. 4 shows a user interface screen showing an electronic incident report form with multiple fields and tabs to be filled by a user to create an incident report;

FIG. 5 shows a user interface screen showing the page of FIG. 4 with a drop-down box of a Routing Profile field displaying selectable pre-defined routing profiles;

FIG. 6 shows a user interface screen showing a Routing page of the electronic incident report form for setting a new routing profile for an incident report;

FIG. 7 shows a user interface screen showing an incident report submitted for review;

FIG. 8 shows a user interface screen showing a case investigation form for initiating an investigation in connection with a reported incident;

FIG. 9 shows a user interface screen showing a report of investigation of a reported incident;

FIG. 10 shows a user interface screen showing a page for entering supplements for a case investigation report;

FIG. 11 shows a user interface screen showing a page for giving temporary access rights to a person to access selected data items; and

FIG. 12 shows a user interface screen showing an audit page that contains a sorted list of incident reports.

### DETAILED DESCRIPTION OF EMBODIMENTS OF THE INVENTION

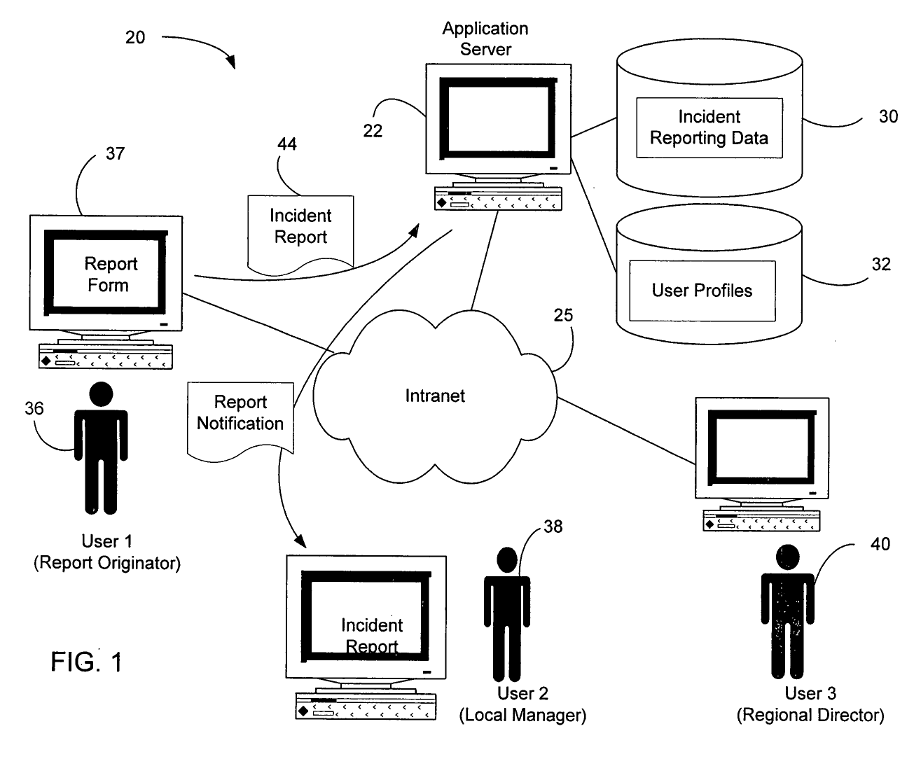

FIG. 1 shows an embodiment of a computerized system 20 for generating and processing incident reports in accordance with the invention. The incident reporting system 20 provides a secured framework for the creation, storage, routing, review, investigation, and auditing of incident reports. In the embodiment shown in FIG. 1, the system 20 includes an application server 22 that resides on a computer connected to a computer network 25. The application server 22 runs software programs that provide the functionalities of the incident reporting system as described below. Users involved in the incident reporting are connected to the application server 22 via the computer network 25. The application server 22 operates as a web server to present various interface screens to facilitate the creation and review of incident reports, as described in detail below. The application server includes one or more databases 30, 32 for storing various types of data, such as data related to the incident reporting and investigation, user profiles identifying role-based rights to access incident reporting data, and data concerning general security measures. The computer network 25 is preferably an intranet of a corporation that implements the incident reporting system 20. The private nature of the intranet simplifies implementation of security measures, such as access control, authentication, and data and communication encryption, etc., required by the incident reporting system. Nevertheless, the intranet may be replaced by a public computer network, such as the internet, if proper measures are implemented to ensure the security of the incident reporting system to prevent unauthorized data access and eavesdropping on network communications.

In the system illustrated in FIG. 1, a user 36 (report originator) that wants to create an incident report accesses the application server 22 via the network 25. Once connected, the application server 22 communicates with the user computer 37 to display user interface screens that present an electronic form or template for an incident report, which the user can use to generate the report. As described in greater detail below, each incident report has a routing profile that specifies a chain of reviewers for that report. After an incident report 44 is created, it is submitted to the application server 22, which stores the report in its database 30. The application server 22 then distributes the incident report to the reviewers (e.g., the users 38 and 40) in the order specified in the routing profile. The application server 22 keeps track of the review progress and all the changes made to the report and actions taken on the report, and logs data creation, reading, update, and deletion by individual users in the database 30 to allow the monitoring and auditing or the report review process.

In accordance with a feature of the invention, the incident reporting system 20 implements security features to ensure the integrity and confidentiality of the incident reporting data and related information. In particular, the system implements role-based security, such that a given user can only access or modify incident reports or other types of information only if that user has been authorized for such access. A role is a predefined set of rights/privileges within an application. The application administrator associates individual users to a role using the authorization profile feature of the system 34. In addition to role-based privileges, additional privileges can be granted to an individual user by the application administrator. The role-based security is combined with the general security of the system to provide effective control over what each user is allowed to do and to see. For general security purposes, each user is required to have a valid user name and a password, and is required to log in with his user name and password before he is allowed to access the functions of the system only if the user successfully. Once the user logs in, the access to the incident reporting data is based on the role-based security. In this regard, each user is given a pre-assigned security authorization level that defines what types of documents the user can see, what changes the user is allowed to make, and what actions the user is able to take in connection with the review of the incident reports. Alternatively or in conjunction with the pre-assigned authorization levels, special permits may be given to a particular user for temporary assess to selected documents. The application server 22 preferably includes a secured database 32 for storing the user profiles 34 separate from the incident reporting data 33 in another database 30, and only authorized system administrators or high-level mangers are allowed to access the user profile data.

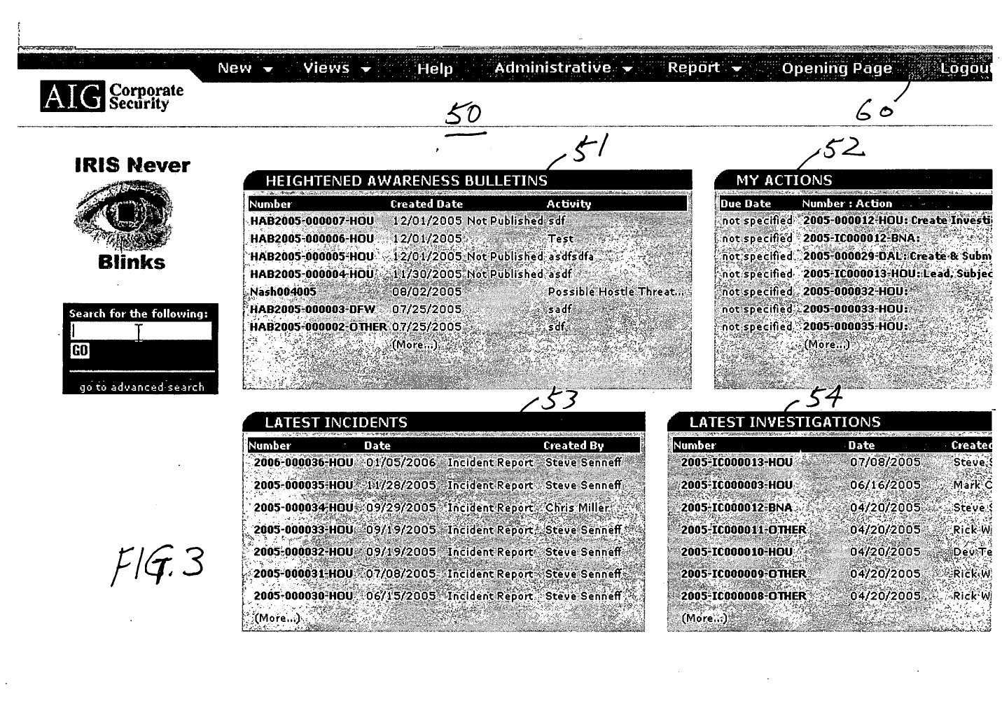

The access rights to the incident reporting data 33 may be based on the corporate management hierarchy. By way of example, FIG. 3 shows an example of a reporting hierarchy 45. The users on different levels of the hierarchy 45 have different access rights. For instance, a local user, who functions as a report originator 46, may use the electronic form provided by the application server 22 to create and submit an incident report. A local report originator 46 may also view other local reports. A local approver 47 can change the data fields or scroll-down menu selection in the electronic report form. The changes have to be submitted to a local administrator 48 for approval. While reviewing a report, the local approver 47 has to fill in the “Approved by” data field before the report can be submitted up along the hierarchy for further review. A local administrator 48 can change the data fields or scroll-down menu selections in the electronic form, add a scroll-down data field. The local administrator 48 can submit report to a regional or global distribution list, and can view all reports in the region. A regional administrator 49 can only alter blank report template, and cannot change processed or finished report data. The regional administrator 49 can also view all reports in the region.

To protect the confidentiality and integrity of the incident reports, incident investigations, and related information, encryption is used to protect the data at rest (i.e., as stored in the database 30) and in transit to users over the network 25. More specifically, the incident reporting data in the database 30 are stored in an encrypted form. Thus, even if a hacker can breach the network security measures and reach the data 33, he will not be able to decipher the data without knowing the encryption key used to encrypt the data. When an authorized user accesses the data over the network 25, the data are transmitted by the application server 22 in an encrypted format to prevent eavesdropping or tampering of the data in transit by an unauthorized entity on the network. The encryption for data transmission during network communication may be session-based using known session-based network security protocols.

To facilitate an understanding of the functions and operation of the incident reporting system, FIGS. 3-12 show various user interface screens presented by the application server for the creation, review, and auditing of incident reports. Turning first to FIG. 3, after a user 36 logs in, the application server 22 presents a user interface screen that displays a user home page 50, from which the user can continue by selecting from various available functions presented in the page. The contents of the user home page 50 depend on the user identity and the authorization profile of the user. Thus, different users may see different user home pages. For instance, the page 50 shown in FIG. 3 may be presented to a manager, who is authorized to see all the incident reports being reviewed in the local region and the related investigations. In contrast, a user of a lower security may be allowed to see only those incident reports created by him and information pertaining to those reports.

In the example shown in FIG. 3, the page 50 includes four panes 51-54: Heightened Awareness Bulletins, My Actions, Latest Incidents, and Latest Investigations. The Heightened Awareness Bulletins (HAB) pane 51 is a document with specific instructions concerning specific individuals. Most of the entries in the HAB are to let supervisors and mangers know that a particular person no longer has access to the facilities of the corporation, and to give a description of the person. A picture of the person may be included in the HAB (e.g., via hyperlinking) to assist in identification of that person. The My Action pane 52 contains a list of all incident reports that have actions requirements for the user to undertake. It does not include inputs of other officers or managers. For instance, the user may have created an incident report and submitted it to his manager for review, and the manager may reject the report and return it to the user for corrections. That incident report will show up in the My Actions pane. The user can click the corresponding entry in the My Actions pane 52 to pull up the incident report to make corrections and resubmit it to the manager. The Latest Incidents pane 53 presents a list of latest incidents that have been reported. The incidents displayed in this pane depend on the access authorization level of the user, and the user can see only those incidents that the user has the proper authorization level to see. The Investigation pane 54 displays a list of latest investigations that have been initiated in response to the review of the incident reports.

At the top of the user home screen 50 is an action menu bar 60 that provides various functions available to the user. For a basic user, the menu bar 60 includes the following actions: NEW, VIEWS, HELP, OPENING PAGE, LOGOUT. The NEW action is selected to create new incident reports, heightened awareness bulletins (HAB), medical safety reports, maintenance reports, miscellaneous reports, and physical security surveys (PSS). The VIEWS action allows the user to select to view incident reports, HAB, PSS, and billing information by case. Again, the application server 22 displays only those reports and information that the user is permitted to see based on the user's access authorization level.

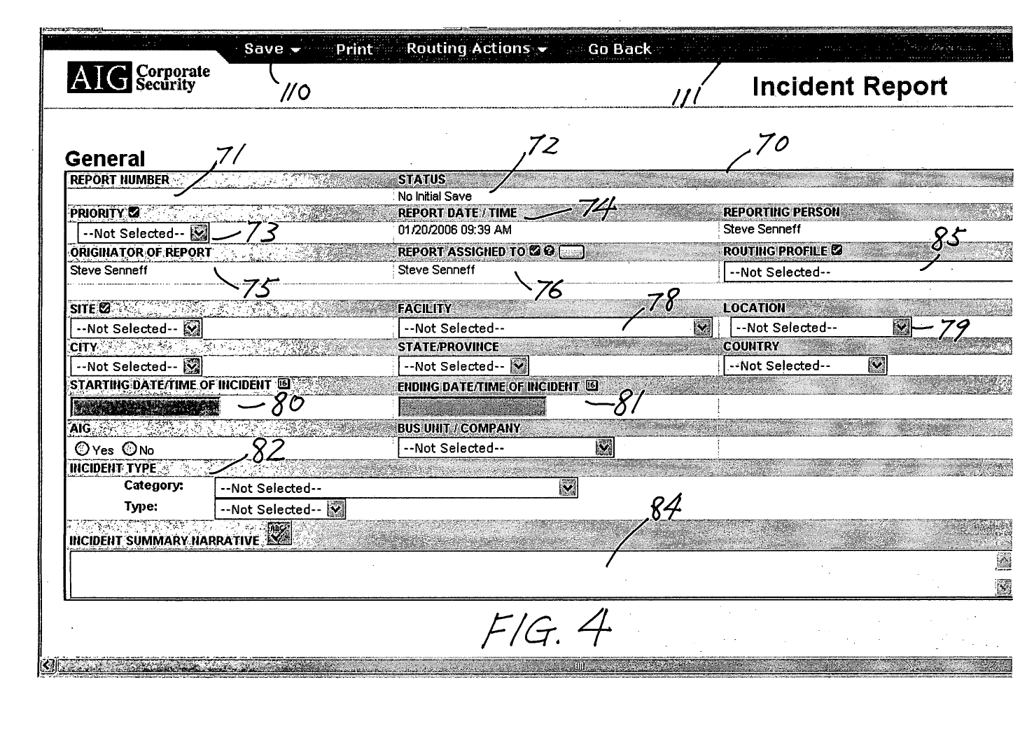

To generate an incident report, a user clicks on the “NEW” action in the menu bar 60 in the user home page. In response, the application server 22 displays a drop-down menu to allow the user to select whether a new incident report, a medical safety report, a maintenance report, a miscellaneous report, a physical security report, or a HAB entry is to be created. To create a new report, the user selects the Incident Report option in the drop-down list. Alternatively, the user may select to work on an incident report that has been created but not yet submitted. To that end, the user selects the pending incident from the incident panel on the dashboard, and clicks the edit button to modify the incident. Once editing is completed, the SAVE function is selected. The user may choose Save as Pending or Save and Submit. In response, the application server 22 displays an electronic form 70 or template for the incident report, as shown in FIG. 4. If it is a new report, the fields in the form are empty. If the report is an existing one, the fields are populated with data that were already entered.

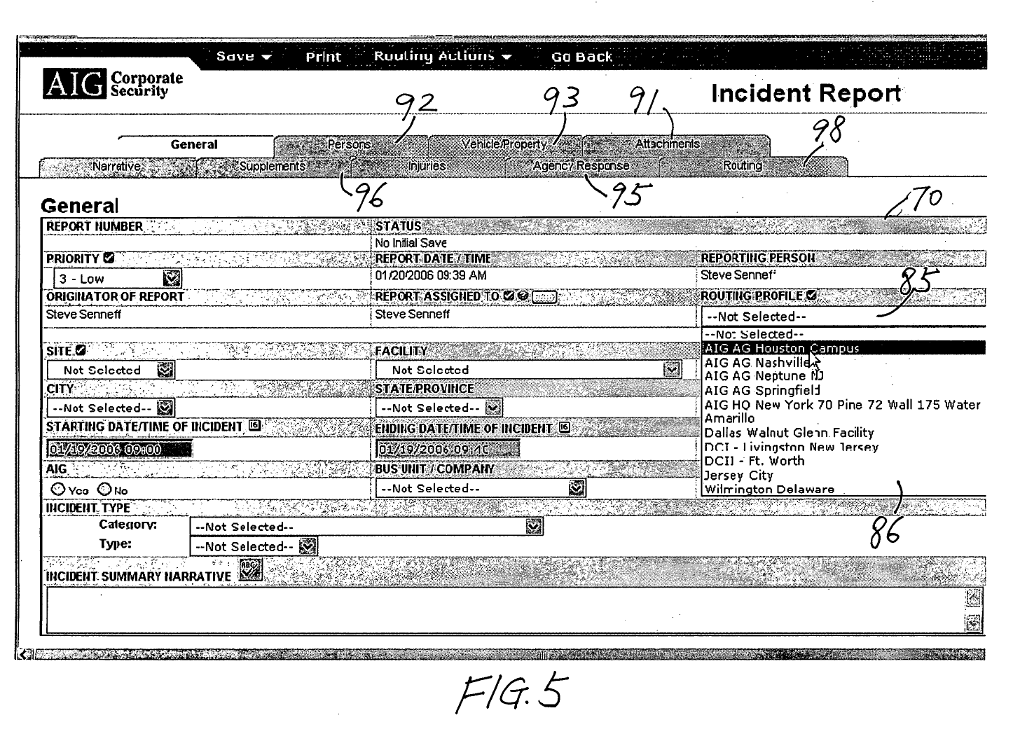

The electronic incident report form contains multiple pages, each identified in the user interface screen 70 by a tab (see FIG. 5). The page associated with the General tab is shown in FIG. 3. It contains basic data fields for the incident form, some of them are to be entered by the user 36 and the other automatically filled by the report generation program running on the application server 22. To simplify the task of data entry and to assist the user 36 in finding the right data, some of the fields may each present a list of possible answers in a drop-down box or another type of user interface window for the user to choose from.

In the General incident report page 70 shown in FIG. 4, the data in the Report Numbers and Status fields 71, 72 are generated automatically by the program once the document is saved. The Priority field 73 is used to specify the priority level of the report. The user has three selections from the drop-down box: High, Medium, and Low. A low priority means that the report is for local distribution only. A report of the medium priority may require reviews by local managers and a regional director. A high priority may require a total regional distribution. Unless a priority level is selected, the program does not allow the user to select a routing profile in a later part of the incident report form.

The Originator of Report field 75 is automatically filled with the name of the user creating the report. The Report Assigned To field 76 is automatically filled with the name of the user creating the report, and the user is not allowed to change this field. The Site field 77 is to be filled with the location of the company branch of the user. The Facility field 78 is to be filled with the name or location of the facility of the company where the user is located. The Location field 79 is used to identify the area in which the incident took place, such as “inside building,” “surface lot,” “loading dock,” “parking garage,” etc. The Starting Incident Date/Time and Ending Incident Date/Time fields 80, 81 are used to specify the starting date/time and ending date/time of the incident. To facilitate data entry, the application server 22 may present a Calendar pop-up window for the user to select the date/time for filling these fields. The Incident Type field 82 is used to identify the type of the incident being reported, and the user may select the proper type from a drop-down box. Besides the fields for collecting basic information regarding the incident being reported, the user can also enter a short narrative in the Narrative box 84.

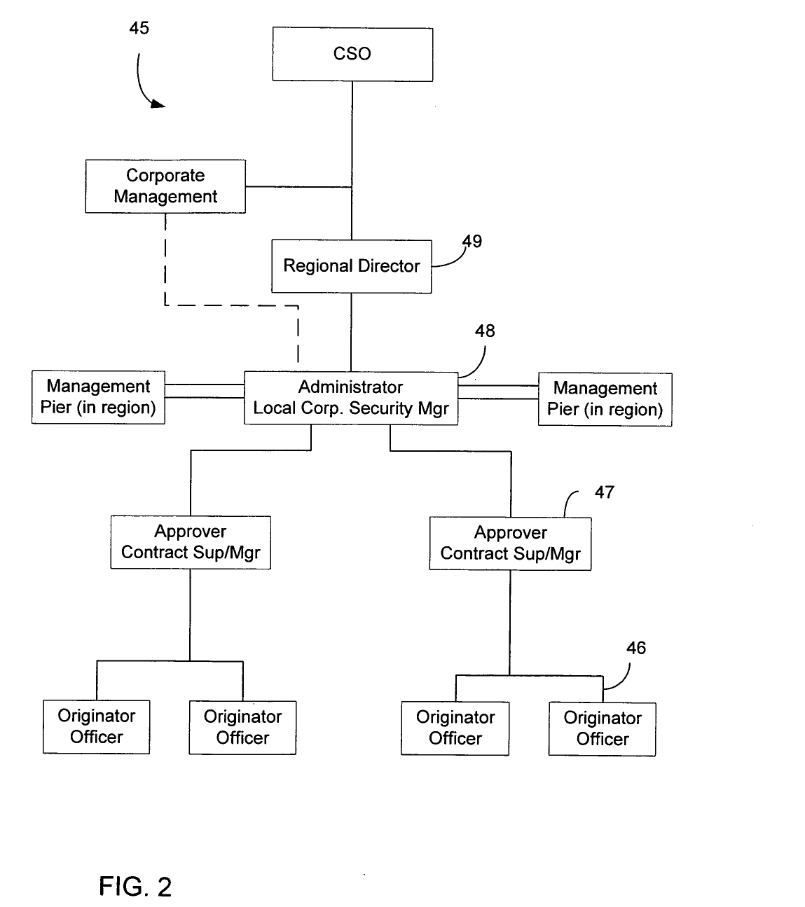

In accordance with a feature of the invention, a “routing profile” is defined for each incident report when the report is created. A routing profile, as explained in greater detail below, is a list of review steps that specifies for each step a specified person for performing that step and the action to be carried out at that step. The routing profile of an incident report does not have to include users from all the access levels, such as those illustrated in FIG. 2. If the situation requires, the routing profile can skip some access levels. For example, a incident report for an incident that is highly sensitive may go directly from the report originator to the top director of the company. By specifying a routing profile for each incident report, the chain of reviewers for that report and what is to be done by each reviewer are clearly identified. As a result, the report is ensure to go to the right reviewers, and the progress of the review process can be closely monitored.

To enable the user to specify a routing profile for a report, the incident report form page 70 of the General tab has a Routing Profile field 85. To simplify the task of specifying the routing profile, a plurality of pre-defined routing profiles may be presented for selection by the user. As illustrated in FIG. 5, when the user movers the cursor into the Routing Profile field 85, the program displays in a drop-down box 86 a list of pre-defined routing profiles. The user can scroll down the list and select a routing profile that is suitable for the incident being reported. In this regarding, the application server 22 may display only a subset of pre-defined routing profiles based on the user identification or other parameters such as the user location, type of incident, etc., instead of displaying all pre-defined routing profiles stored in its database.

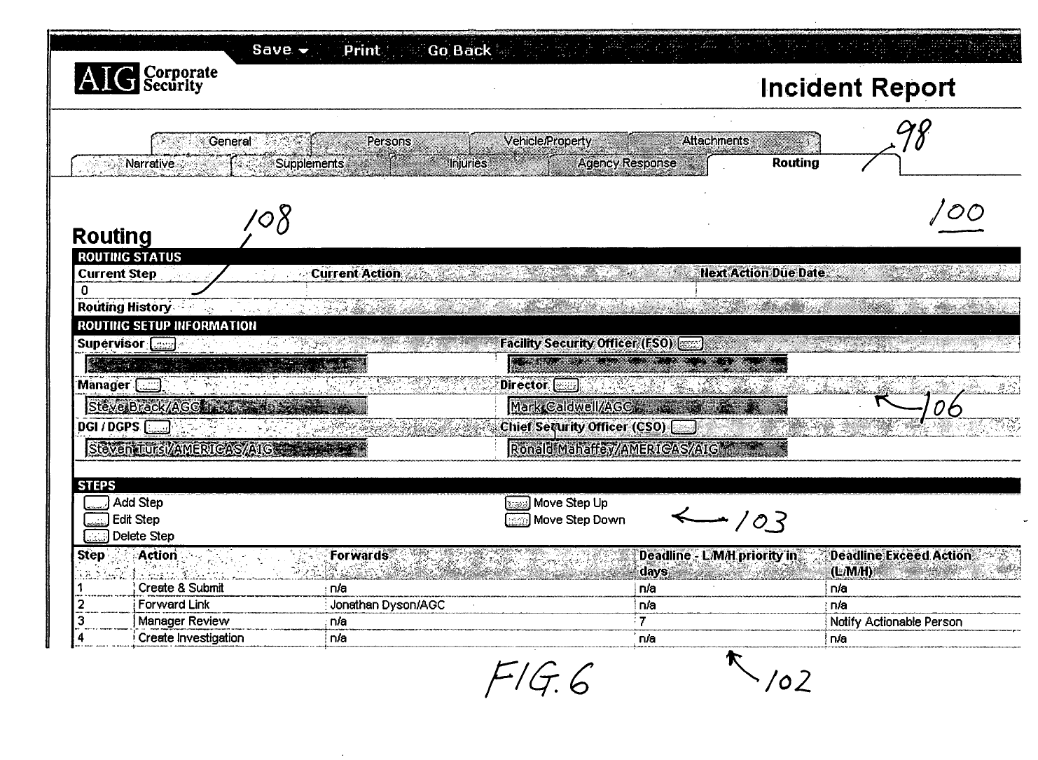

As described above, the user may select an appropriate pre-defined routing profile for the incident report being generated. If, however, none of the pre-defined routing profiles is suitable for the incident report, the user may create a new routing profile. Alternatively, the routing profile may be created by the supervisor of the report originator. To generate a routing profile, the Routing tab 98 is selected. In response, the application server presents a Routing Profile page 100, as shown in FIG. 6. The Routing page 100 displays a list 102 of steps to be taken with respect to the incident report. Each step requires an action, and is to be performed by one identified user, which may be the report originator or one of the reviewers. The actions include, for example, Create & Submit, Forward Link, Manager Review, create investigation, and Director Review. The step editing buttons 103 allows the user to add, edit, or delete a step from the list in the Steps pane, or move a step up and down the list. The Routing Set Up Information pane 106 includes fields for identifying the supervisor, manger, DGI/DGP, the facility security officer, the director, and Chief Security Office that may be selected as reviewers for the report. As mentioned above, the routing profile of an incident report does not have to include users from all the access levels. Once the incident report is submitted, the Current Step field 108 is used to show the current review step, and the action to be taken in this step. Thus, a user accessing the incident report can see the review status of the report.

Besides the General tab, the electronic report form 70 has a plurality of other tabs, which the user can use to enter other relevant information for the incident report. These tabs, as shown in FIG. 5, include: Persons, Vehicle/Property, Attachments, Narrative, Supplements, Injuries, Agency Response, and Routing. The Attachment tab 91 is used to include attachments to the incident report. An attachment may be a document, picture, video clip, audio clip, or data in other formats. To use the attachment feature, the user has to have the ability to download the data for the attachment from an existing media source. The Person and Vehicle/Property tabs 92, 93 are used to enter information regarding the person, vehicle, or property involved in the incident. The Supplements tab 94 allows the user to enter supplemental information regarding persons, vehicles, or properties involved in the incident. The Agency Response tab 95 is selected when the user needs to identify the company or outside entities that were involved in handling the incident. For example, an internal theft may have to involve the local police depending on the value stolen or other circumstances. The Injuries tab 96 allows the user to identify the injuries involved in the incident. The user may dynamically display the information in a tabular landscape/horizontal orientation, or may change the information display to a scrollable vertical presentation by selecting a display option.

To save an incident report being created, the user clicks on the “Save” button 110 in the menu bar 111 shown in FIG. 4. In response, the application server 22 presents two options for saving the report: Save As Pending and Save and Submit as Final. If the incident report is not finalized, and the user intends to work on it again, the user can save the report as “pending” by choosing the Save As Pending option. In response, the application server 22 saves the incident report, with all the data entered into the report up to that point, in the database 30, without forwarding it to any person in the routing profile. When saved as “pending,” the report can be re-accessed, and information may be amended or added at a later date. The local manager will have the ability to see pending reports, so that he can see the status of an incident report before it is finalized by the report originator.

If, on the other hand, the report is completed and the user wants to submit it and start the review process, the user selects the “Save and Submit” option. In response, the application server 22 saves the report in its database 30, and forwards the report to the first reviewer (e.g., the site manager 38) listed in the routing profile of the incident report. Even after the report is submitted, changes can still be made to the report by authorized reviewers. Any such changes, however, will be logged to show the review history and to ensure accountability for modification of the report.

Referring back to the FIG. 1, a reviewer 38 accesses an incident report via the application server 22. In this regard, the “routing” of an incident report to a reviewer 38 specified in the routing profile of the report is done by sending a notification 45, such as an email message, to the reviewer 38. The notification may include a link to the incident report. When the reviewer clicks on the link, the computer of the reviewer is connected to the application server 22. Once the reviewer 38 logs in properly, the application server 22 displays the incident report for viewing by the reviewer. Alternatively, the reviewer may go the website of the application server 22, log in, and pull up a list of all incident reports that are to be reviewed by him.

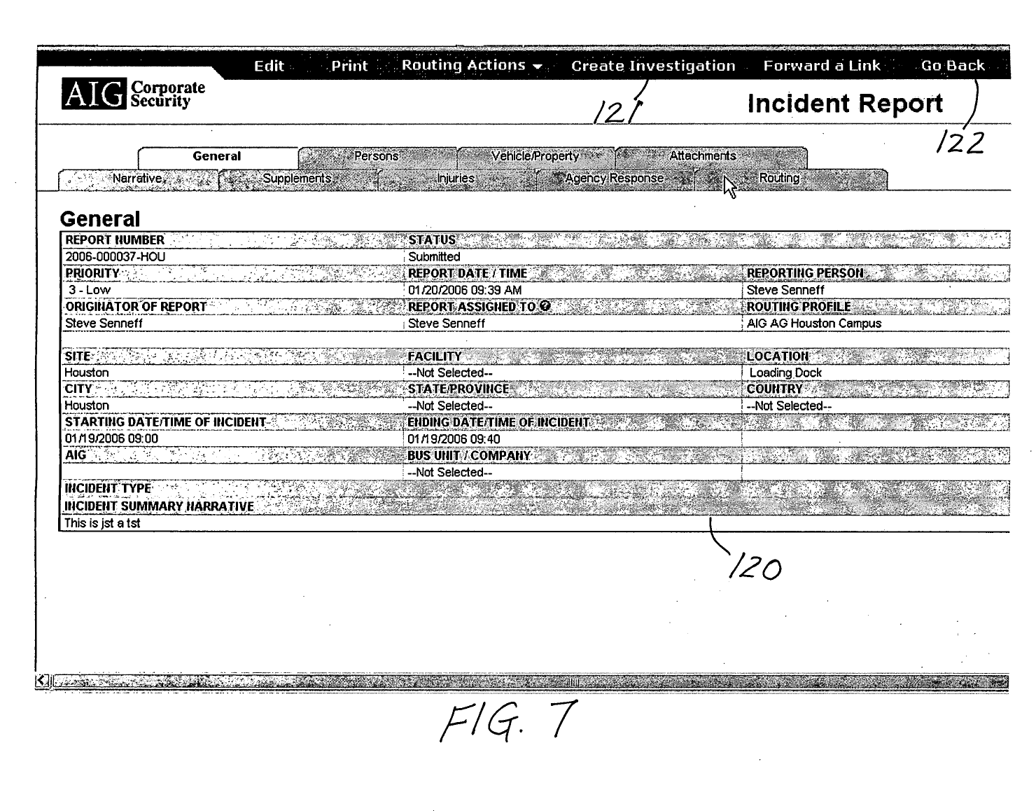

FIG. 7 shows a submitted incident report 120 as seen by a reviewer. When the reviewer reviews an incident report, she goes through the report and identifies any item in the report that should be modified or corrected. A manager or director reviewing an incident report has four options. First, the reviewer can accept the report. In that case, the application server modifies the status data for that incident report to indicate completion of review by that reviewer, and forwards the report to the next reviewer identified in the routing profile. It also sends a notification to the previous sender regarding the acceptance. Second, a director has the option to forward an incident report to other managers for their review. Commends may be attached to the forwarded report. Third, a manager or director can make changes to the report before accepting or forwarding the report. Fourth, if any change is required, the reviewer may “reject” the report, and send the report with comments back to the previous sender in the routing profile. The previous sender then makes the changers and resubmits the report. Once an incident report has been submitted, the application server 22 keeps track of all changes made to the report, and logs the changers in its database 30. The application server 22 also keeps track of the review process by recording which reviewer in the routing profile has reviewed the report. By storing the progress tracking data for the incident reports in the database, the incident reporting system provides an audit trail for each incident report. A manager or director can quickly find out who has reviewed the report and which actions have been taken. When a reviewer indicates that she has finished reviewing the incident report by accepting the report,

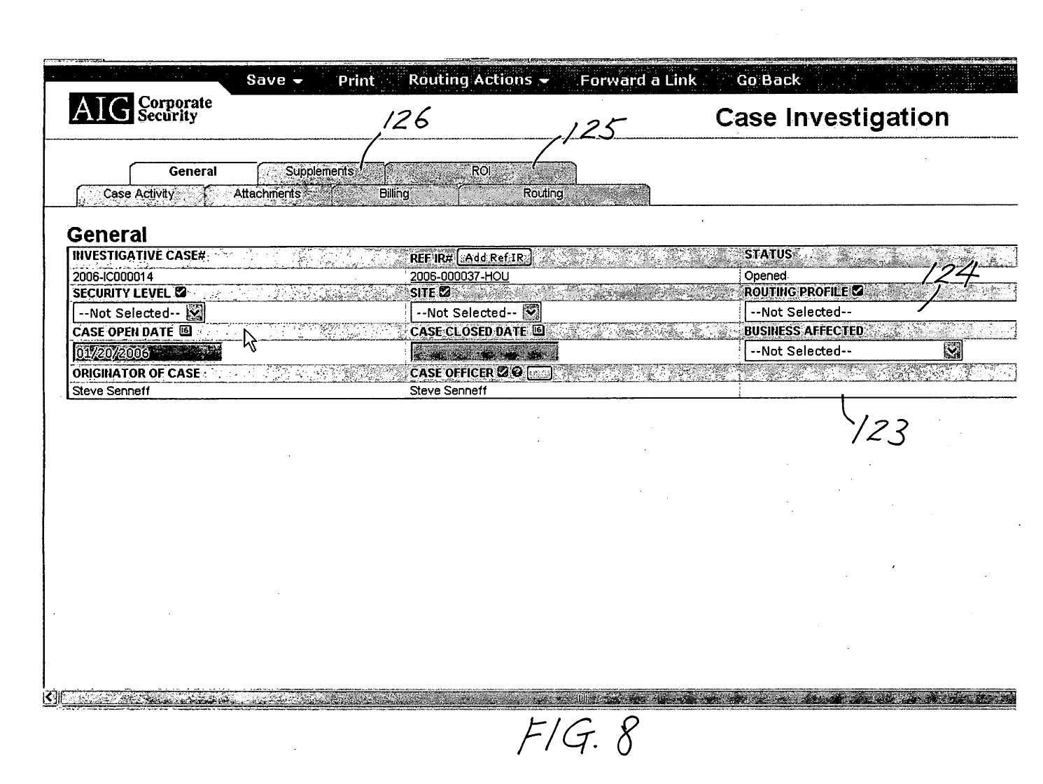

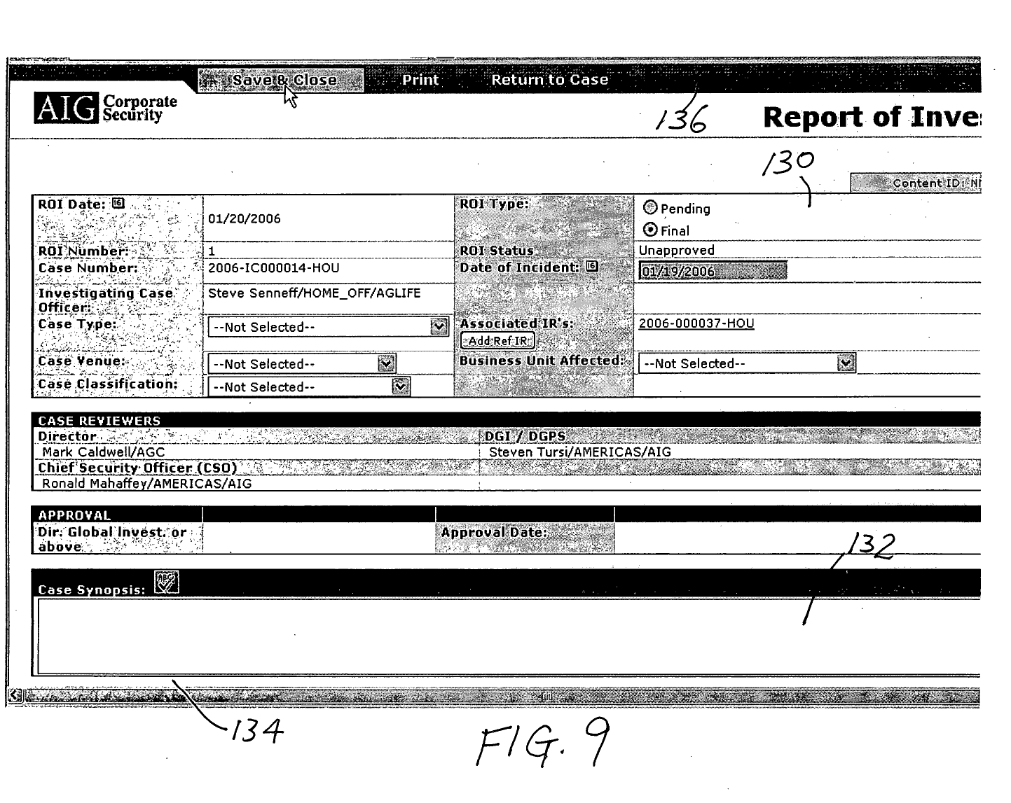

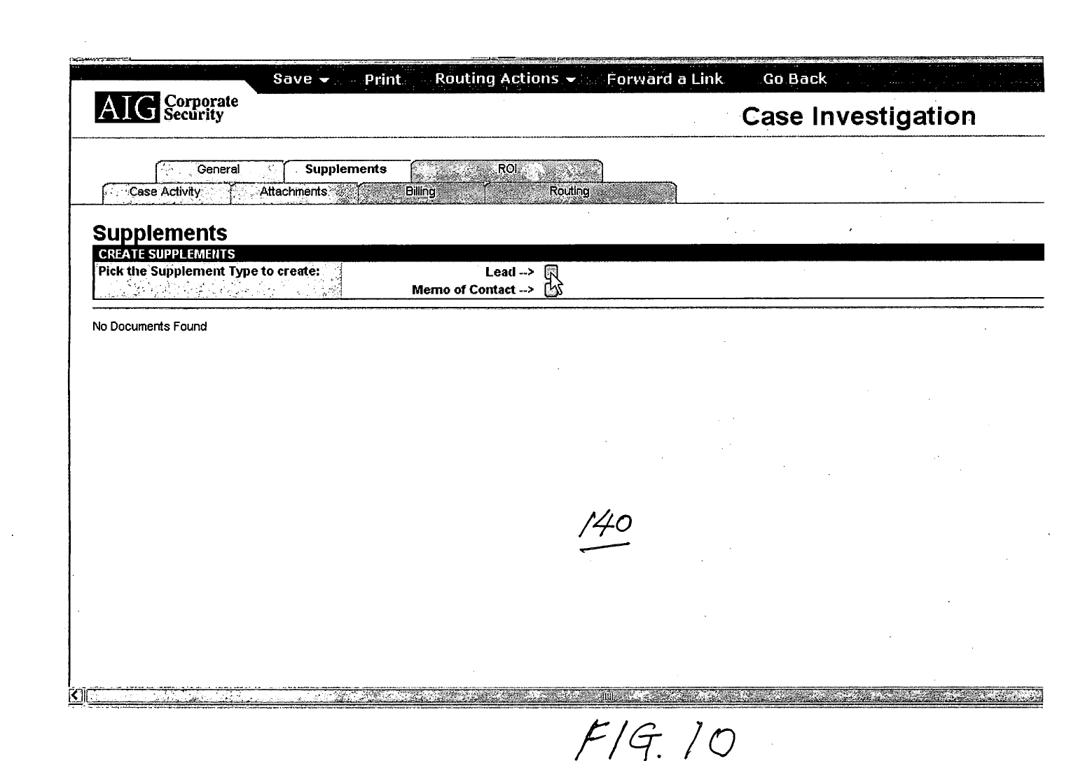

One action a reviewer can take is to create an investigation for an incident report being reviewed. An investigation form is displayed when the user clicks on the Create Investigation button 121 in the menu bar 122 in FIG. 7. In response, the application server 22 presents a case investigation form 123, as shown in FIG. 8, for the user to fill in the fields. Like the incident report form, the case investigation form has a Routing Profile field 124 that requires the user to select a routing profile for the investigation report. When the user selects the ROI tab 125 of the form, a Report of Investigation form 130 is displayed, as shown in FIG. 9. This page contains fields showing data identifying the investigation, a Case Synopsis field 132 for the user to enter a case synopsis, and a Case Details field for the user to provide a detailed description of the incident and how it is handled. If the user selects the Supplements tab 126 in the case investigation form in FIG. 8, the application server 22 displays a page 140 as shown in FIG. 10 to allow the user to enter information regarding a lead or memorandum of contact. Once the fields in the case investigation form are filled, the user clicks on Save & Close option in the action menu bar 136 (FIG. 9) to save the investigation report.

The above description has described the creation of incident reports and investigations. It will be appreciated that other types of documents, such as HAB and PSS, can be created in like manner by users of proper access rights.

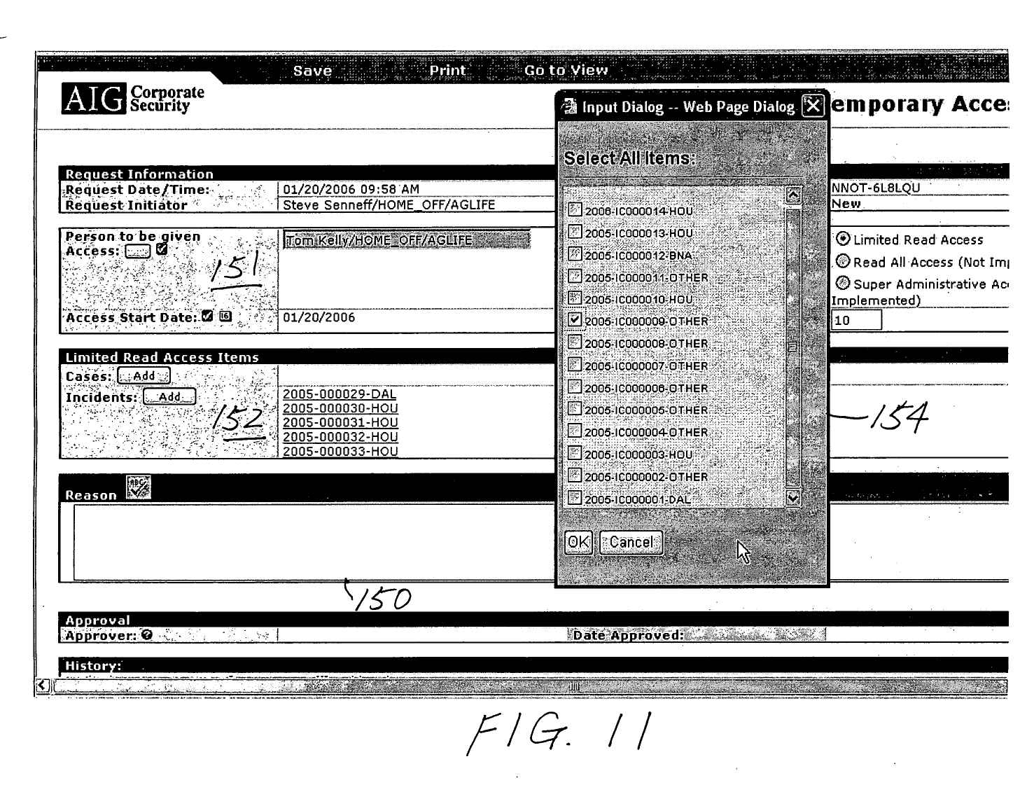

Besides the assess rights associated with a given security level, a user may be given temporary access to selected incident reports and related data. To set up the temporary access, a user with proper authority selects the Administrative function in action menu bar 60 in the user home screen (FIG. 2), and selects the Temporary Access Request View in the drop-down list. In response, the application server 22 displays a Temporary Access Request page 150 as shown in FIG. 11. The “Person to be Given Access” field 151 is used to identify the person to whom the temporarily access right is to be given. The Limited Read Access Items field 152 is for the user to specify the items to which the person has temporary access. To assist the user identifying such items, the application server 22 displays a dialog box 154 that contains all data items, from which the user can select the ones for temporary access. The items selected by the user are entered into the field 152.

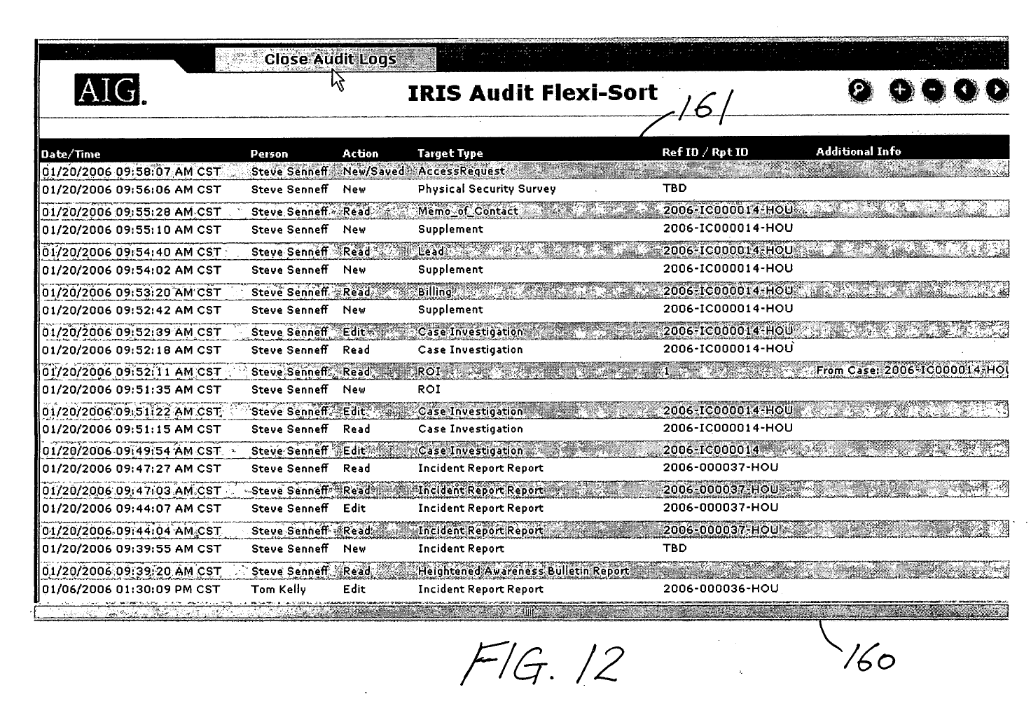

By storing the progress tracking data for the incident reports in the database 30, the incident reporting system provides an audit trail for each incident report. A manager or director can find out quickly who has reviewed the report and which actions have been taken. By way of example, FIG. 12 shows a user interface screen 160 for auditing the handling of incident reports. The user can view the incident reports sorted according to different attributes of the reports, such as Date/Time, Person, Action, etc., that are given in the menu bar 161. The user can click on one of the attributes to see the incident reports sorted according to that attribute. Various types of reports regarding the reported incidents can also be generated using the data 33 stored in the database 30.

In view of the many possible embodiments to which the principles of this invention may be applied, it should be recognized that the embodiment described herein with respect to the drawing Figures is meant to be illustrative only and should not be taken as limiting the scope of invention. Those of skill in the art will recognize that the elements of the illustrated embodiments can be modified in arrangement and detail without departing from the spirit of the invention. Therefore, the invention as described herein contemplates all such embodiments as may come within the scope of the following claims and equivalents thereof.

1. A computer-assisted system for incident reporting, comprising:
an application server on a computer located on a network and communicating with a user computer on the network, the application server being programmed to present through user interface screens on the user computer an incident report form with data fields for entering information regarding an incident to create an incident report, the data fields including a field for a routing profile for the incident report, the routing profile specifying a list of review steps identifying a reviewer for each review step and an action to be carried out at said each step, the application server being further programmed to forward said incident report to reviewers identified in the routing profile for review thereof, and
a first database connected to the application server for storing the incident report and a review status of the incident report, wherein data in the first database are stored in an encrypted format.

2. A system as in claim 1, wherein the network is an intranet.

3. A system as in claim 1, wherein the network is the internet.

4. A system as in claim 1, wherein the application server is programmed to transmit the incident report over the network in an encrypted format to a reviewer identified in the routing profile for review thereof.

5. A system as in claim 4, wherein the application server is programmed to forward the incident report to a reviewer identified in the routing profile by sending a notification message to said reviewer regarding the incident report.

6. A system as in claim 5, wherein the notification message includes a link for the incident report.

7. A system as in claim 1, wherein the application server is programmed to present a user interface screen displaying a routing configuration page for setting up a routing profile for the incident report.

8. A system as in claim 1, wherein the application server is further programmed to display a list of available pre-defined routing profiles selectable for filling the routing profile field of the incident report form.

9. A system as in claim 8, wherein the application server is programmed to update the review status for the incident report upon completion of review of the incident report by a reviewer identified in the routing profile.

10. A system as in claim 1, further including a second database for storing user profiles for users of the system, the user profile for each user defining access rights of said each user, and wherein the application server is programmed to determine whether to allow said each user to assess the incident report stored in the first database based on the user profile of said each user.

11. A method of processing incident reports, comprising:
presenting an incident report form through electronic user interface screens transmitted over a network to a user computer for creating an incident report, the incident report form having data fields regarding an incident to be reported and including a field for a routing profile for the incident report, the routing profile specifying a list of review steps identifying a reviewer for each review step and an action to be carried out at said each step;
storing the incident report and a review status of the incident report in a database in an encrypted format; and
forwarding the incident report to reviewers identified in the routing profile for review thereof.

12. A method as in claim 11, wherein the step of forwarding includes transmitting the incident report over the network in an encrypted format.

13. A method as in claim 12, wherein the step of forwarding includes sending a notification message to a reviewer regarding the incident report.

14. A method as in claim 13, wherein the notification message includes a link for the incident report.

15. A method as in claim 11, wherein the step of presenting includes displaying a routing configuration page for setting up a routing profile for the incident report.

16. A method as in claim 11, wherein the step of presenting includes displaying a list of available pre-defined routing profiles selectable for filling the routing profile field of the incident report form.

17. A method as in claim 11, further including the step of updating by the application server the review status of the incident report upon completion of review of the incident report by a reviewer identified in the routing profile.

18. A method as in claim 11, further including the steps of checking a user profile for a user regarding access rights of said user, and determining whether to allow said user to assess the incident report based on the user profile.

19. A method as in claim 11, wherein the network is an intranet.

20. A method as in claim 11, wherein the network is the internet.
